(19) United States
(12) Patent Application Publication
(10) Pub. No.: US 2009/0272332 A1
(43) Pub. Date: Nov. 5, 2009

(54) PET GROOMING COMB CAPABLE OF CHANGING TEETH

(75) Inventor: Ralph LIN, Taipei (TW)

Correspondence Address: BROWDY AND NEIMARK, P.L.L.C.;624 NINTH STREET, NW, SUITE 300, WASHINGTON, DC, 20001-5303, US

(73) Assignee: Han Lien International Corp., Taipei (TW)

(21) Appl. No.: 12/233,953

(22) Filed: Sep. 19, 2008

(30) Foreign Application Priority Data
May 1, 2008 (TW) 97207578

(51) Int. Cl. A01K 13/00

(52) U.S. Cl. 119/633; 119/625

(57) ABSTRACT

A pet grooming comb includes a grip and a comb head. The comb head has a comb bar connected to the grip, and a comb plate provided with a base portion detachably mounted to the comb bar, and a plurality of teeth mounted to the base portion. A user can use different comb plates that have different types of teeth to comb different characteristics of a pet's hair, thereby enhancing convenience of use.

### BACKGROUND OF THE INVENTION

1. Field of the Invention

The present invention relates generally to pet supplies, and more specifically to a pet grooming comb that is capable of changing various kinds of teeth subject to a user's need.

2. Description of the Related Art

A conventional pet grooming comb generally includes a grip, a comb head fixed to the grip, and a plurality of teeth fixed to the comb head such that a user can hold the grip to force the teeth to comb a pet's hair.

Since the comb head is fixed to the grip and the teeth are fixed to the comb head, the pet grooming comb provides a single type of teeth. However, different kinds of pets have different characteristics of hair, such as length or denseness, or even a pet has different characteristics of hair at different positions. Under this circumstance, the user will consume much time in combing different characteristics of the pet's hair and acquire an inferior effect of combing the hair by using single pet grooming comb; nevertheless, if several pet grooming combs that have different types of teeth are used to comb the pet's hair, the user will need to spend a lot of money to buy them beforehand. Thus, the conventional pet grooming comb has the drawback that it can not change its teeth according to the characteristics of the pet's hair, resulting in inconvenience of use.

### SUMMARY OF THE INVENTION

The present invention has been accomplished in view of the above-noted circumstances. It is one objective of the present invention to provide a pet grooming comb, which can change various kinds of teeth to comb different characteristics of a pet's hair.

To achieve this objective of the present invention, the pet grooming comb comprises a grip and a comb head including a comb bar connected to the grip and a comb plate having a base portion detachably connected to the comb bar and a plurality of teeth mounted on the base portion.

Accordingly, a user can dismount the comb plate from the comb bar so as to change another comb plate that provides different type of teeth, thereby enhancing the convenience of combing the pet's hair.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a pet grooming comb according to a preferred embodiment of the present invention;

FIG. 2 is a perspective view of the pet grooming comb according to the preferred embodiment of the present invention;

FIG. 3 is a sectional view taken along line 3-3 of FIG. 2;

FIG. 4 is a top view of the grip of the pet grooming comb according to the preferred embodiment of the present invention;

FIG. 5 is a bottom view of the grip of the pet grooming comb according to the preferred embodiment of the present invention;

FIG. 6 is a sectional view taken along line 6-6 of FIG. 2;

FIG. 7 is an exploded bottom view of the comb bar and the comb plate of the pet grooming comb according to the preferred embodiment of the present invention;

FIG. 8 is an assembled sectional view of the comb bar and the comb plate of the pet grooming comb according to the preferred embodiment of the present invention;

FIG. 9 is an exploded view of the comb head of the pet grooming comb according to the preferred embodiment of the present invention, showing a comb plate that has different type of teeth is provided;

FIG. 10 is similar to FIG. 9, showing another comb plate that has different type of teeth is provided;

FIG. 11 is a perspective view of the pet grooming comb according to the preferred embodiment of the present invention, showing the comb head is rotated, and

FIG. 12 is a sectional view taken along line 12-12 of FIG. 11.

### DETAILED DESCRIPTION OF THE INVENTION

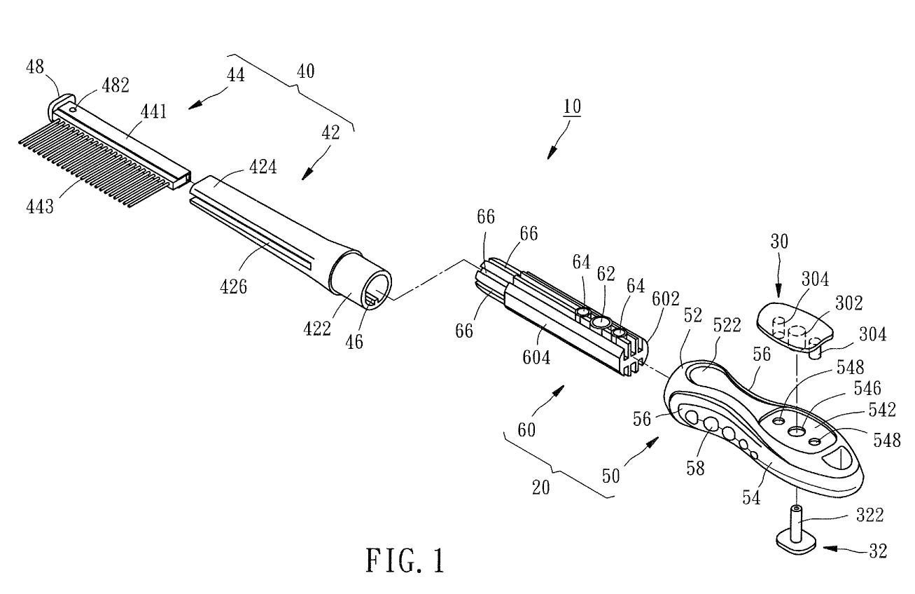

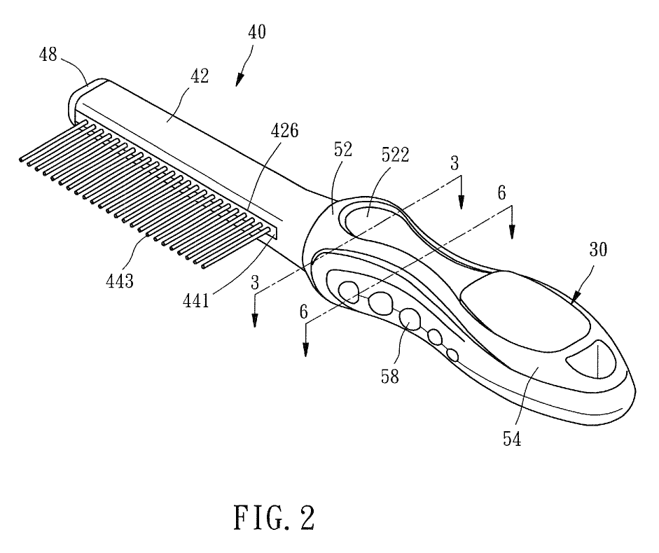

As shown in FIGS. 1 and 2, a pet grooming comb 10 in accordance with a preferred embodiment of the present invention comprises a grip 20, two decorative boards 30 and 32, and a comb head 40.

The grip 20 has a housing 50 and a shaft 60. The housing 50 has a head portion 52, a body portion 54, a first concavity 522 at each of top and bottom sides of the head portion 52 for accommodation of a user's thumb or forefinger, a second concavity 542 at a top side of the body portion 54, and a third concavity 544 at a bottom side of the body portion 54. The housing 50 has an inner cambered surface 562 at a periphery of a shaft hole thereof, and an inner plane 64 opposite to the inner cambered surface 562, as shown in FIG. 6. Further, the body portion 54 has a first outer through hole 546 penetrating through top and bottom sides of the body portion 54 in communication with the second concavity 542 and the third concavity 544 and the shaft hole, and two second outer through holes 548 penetrating through top side of the body portion 54 in communication with the second concavity 542 and the shaft hole and located at places corresponding to two opposite sides of the first outer through hole 546. In addition, a junction of the head portion 52 and the body portion 54 is inwardly shrunken to form two opposite inwardly curved surfaces 56, and a plurality of anti-slip blocks 58 are spacedly provided at each of the curved surfaces 56 and arranged in a straight manner from the head portion 52 to the body portion 54 for providing a skidproof effect.

The shaft 60 has an outer cambered surface 602, an outer plane 604 opposite to the outer cambered surface 602, an inner through hole 62 penetrating through top and bottom sides thereof, and two mounting holes 64 recessed from the top side thereof. The shaft 60 is inserted into the shaft hole of the housing 50 in such a manner that the inner through hole 62 and the mounting holes 64 are respectively aligned with the first outer through hole 546 and the second outer through holes 548, and the outer cambered surface 602 and the outer plane 604 are respectively abutted against the inner cambered surface 562 and the inner plane 564, resulting in that the shaft 60 is not rotatable relative to the housing 50 randomly. Further, the shaft 60 has eight recesses 66 equiangularly and spacedly arranged at a periphery thereof around a longitudinal axis of the shaft 60.

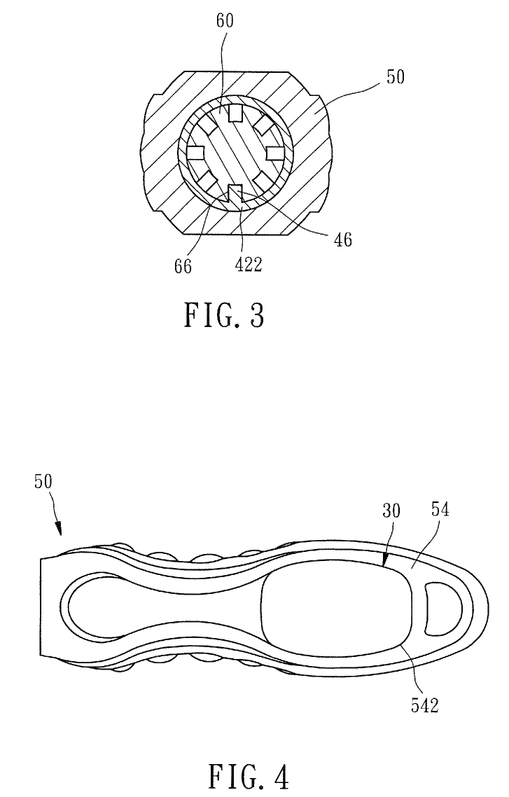

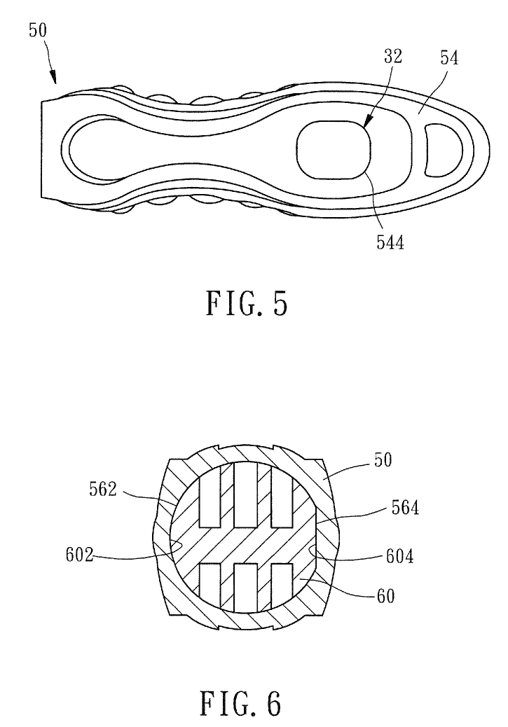

The decorative board 30 has a first post 302 inserted in the first outer through hole 546 of the housing 50 and the inner through hole 62 of the shaft 60, and two second posts 304 respectively inserted in the second outer through holes 548 of the housing 50 and the mounting holes 64 of the shaft 60 such that the decorative board 30 is accommodated in the second concavity 542, as shown in FIGS. 2 and 4. The decorative board 32 has a third post 322 inserted in the first post 302 of the decorative board 30 through the first outer through hole 546 and the inner through hole 62 such that the decorative board 32 is accommodated in the third concavity 544, as shown in FIG. 5. As a result, the shaft 60 can not move along an axial direction of the housing 50 due to the engagement of the decorative boards 30 and 32. In addition, patterns or trademarks can be designed on the decorative boards 30 and 32 according to the user's need.

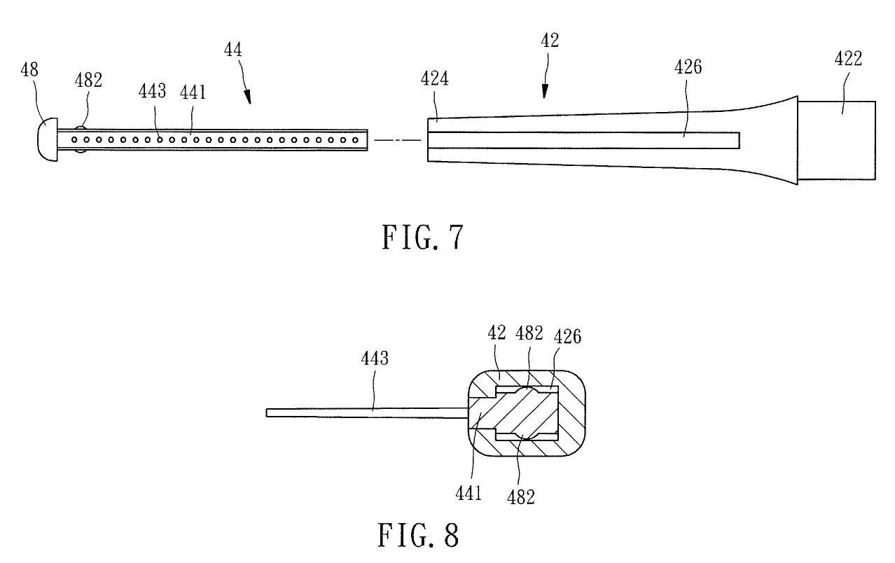

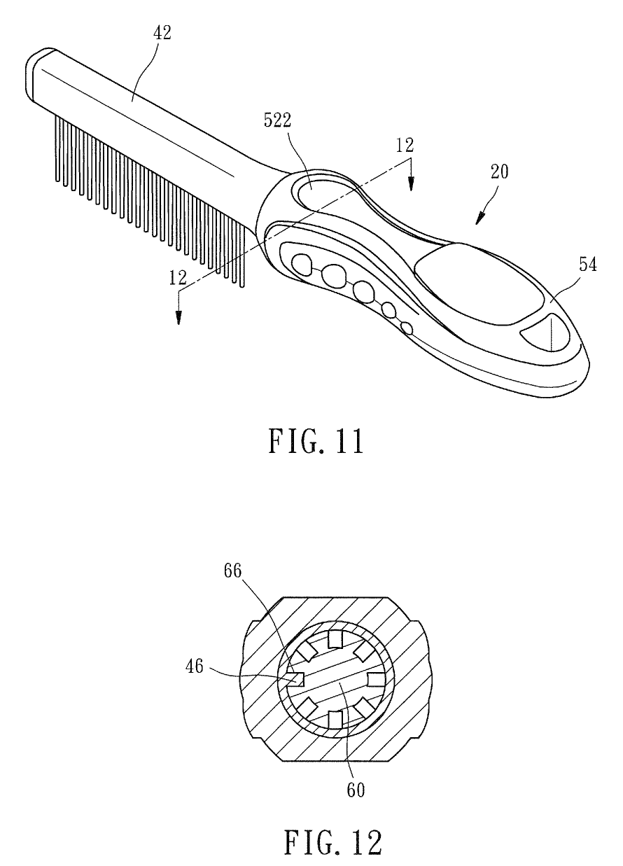

As shown in FIGS. 7 and 8, the comb head 40 has a comb bar 42 and a comb plate 44. The comb bar 42 has a first end 422 of a tubular form provided at an inner periphery thereof with a protrusion 46, which is selectively insertable into one of the eight recesses 66 of the shaft 60 such that the comb bar 42 can be set to one of the eight angles relative to the grip 20, as shown in FIGS. 3 and 12, a second end 424, and an insertion groove 426 extending from the second end 424 toward the first end 422. The comb plate 44 has a base portion 441, a block 48 at a distal end of the base portion 441, two dots 482 respectively provided at two opposite sides of the base portion 441 and adjacent to the block 48, and a plurality of teeth 443 rotatably mounted on the base portion 441. The comb plate 44 is fitted to the comb bar 42 in such a way that the base portion 441 is inserted into the insertion groove 426 until the block 48 is blocked by the second end 424 of the comb bar 42, and the dots 482 are stopped against a periphery of the insertion groove 426.

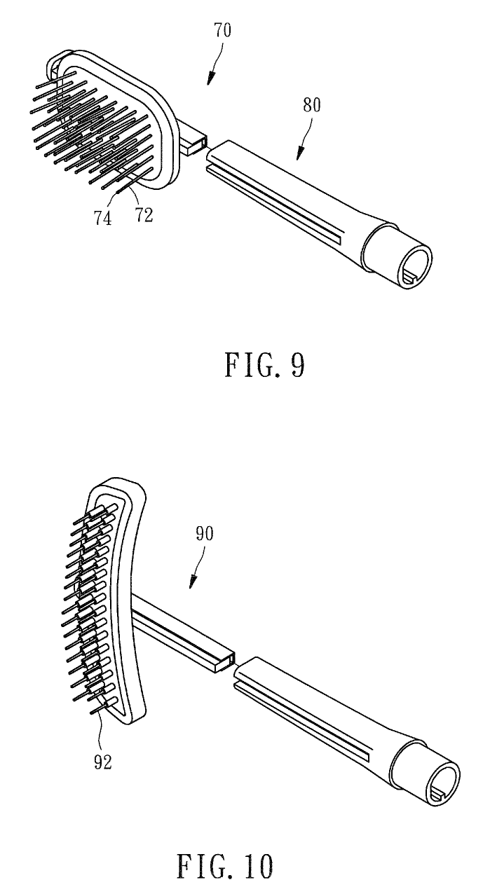

By the aforesaid design, when the user uses the pet grooming comb 10 of the present invention to comb a pet's hair, the pet's hair won't be knotted by means of the 360 degree rotatable teeth 443; moreover, when the user would like to change different type of teeth 443, the user needs only to draw the base portion 441 of the comb plate 44 away from the insertion groove 426 of the comb bar 42 to dismount the comb plate 44 from the comb bar 42, and then insert a new comb plate, such as the comb plate denoted by reference numeral 70 in FIG. 9, that has different kind of teeth into the insertion groove 426 of the comb bar 42. As shown in FIG. 9, the teeth 72 of the comb plate 70 each have a sphere 74 at a distal end thereof to increase the contact area between each one of the teeth 72 and the pet's hair. FIG. 10 shows another comb plate 90 that has double rows of tapered teeth 92 to prevent the pet's hair from knotting.

In addition, the setting angle of the comb bar 42 can be adjusted through the arrangement of the protrusion 46 and the recesses 66, as shown in FIGS. 11 and 12, for enabling the user to choose a labor-saving angle to operate; and furthermore, when holding the grip 20, the user can hold the body portion 54 of the housing 50 to exert a force or place a thumb or forefinger on either of the concavities 522 of the top and bottom sides of the head portion 52 of the housing 50 for enabling the user to operate the grip 20 comfortably and effortlessly due to its ergonomic design.

Certainly, the pet grooming comb of the present invention can be made with various kinds of design on the basis of the spirit of the present invention. For example, the first concavity is not necessary to be formed on each of the top and bottom sides of the head portion. It can be formed on either of the top and bottom sides of the head portion. Further, the body portion of the housing and the shaft can be respectively provided with one or more second outer through holes and mounting holes, or even the arrangement of the second outer through holes and mounting holes can be eliminated. Besides, the shaft can be eliminated if the recesses are directly formed on the periphery of the shaft hole of the housing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pet grooming comb comprising:
a grip; and
a comb head having a comb bar connected to said grip, and a comb plate provided with a base portion detachably mounted to said comb bar and a plurality of teeth mounted to said base portion.

2. The pet grooming comb as claimed in claim 1, wherein said comb bar of said comb head has an insertion groove for insertion of said base portion of said comb plate.

3. The pet grooming comb as claimed in claim 2, wherein said base portion of said comb plate has two dots abutted against a periphery of said insertion groove of said comb bar.

4. The pet grooming comb as claimed in claim 1, wherein said comb bar has a first end detachably connected to said grip, and a second end; said base portion of the comb plate has a block at a distal end thereof abutted against said second end of said comb bar.

5. The pet grooming comb as claimed in claim 4, wherein said grip has a housing and a shaft inserted in said housing and detachably connected to said first end of said bar.

6. The pet grooming comb as claimed in claim 5, wherein said shaft of said grip is provided at a periphery thereof with a plurality of recesses spacedly arranged around a longitudinal axis thereof, and said first end of said comb bar has a protrusion selectively inserted one of said recesses.

7. The pet grooming comb as claimed in claim 5, wherein an inner periphery of said housing of said grip has an inner cambered surface and an inner plane opposite to said inner cambered surface, and an outer periphery of said shaft has an outer cambered surface abutted against said inner cambered surface and an outer plane opposite to said outer cambered surface and abutted against said inner plane.

8. The pet grooming comb as claimed in claim 5, wherein said housing of said grip has a head portion, a body portion, a concavity at either of top and bottom sides of said head portion, and two opposite curved surfaces at a junction of said head portion and said body portion.

9. The pet grooming comb as claimed in claim 8, further comprising a plurality of anti-slip blocks spacedly provided at each of said curved surfaces and arranged in a straight manner from said head portion to said body portion.

10. The pet grooming comb as claimed in claim 8, wherein said body portion is provided at each of top and bottom sides with a concavity for accommodation of a decorative board.

11. The pet grooming comb as claimed in claim 10, wherein said body portion of said housing has an outer through hole penetrating through said top and bottom sides thereof and communicating with said concavities of said top and bottom sides thereof, and said shaft has an inner through hole aligned with said outer through hole, and said decorative boards each have a post inserted in said outer and inner through holes, wherein said post of one of said decorative boards is inserted in said post of the other of said decorative boards.

12. The pet grooming comb as claimed in claim 10, wherein said body portion of said housing has a first outer through hole penetrating through said top and bottom sides thereof and communicating with said concavities of said top and bottom sides thereof, and a second outer through hole penetrating through one of said top and bottom sides of the body portion to communicate with one of said concavities of said top and bottom sides of the body portion; said shaft has an inner through hole aligned with said first outer through hole and a mounting hole aligned with said second outer through hole; one of said decorative boards has a first post inserted in said first outer through hole and said inner through hole and a second post inserted in said second outer through hole and said mounting hole, and the other of said decorative boards has a third post inserted in said first post through said first outer through hole and said inner through hole.

13. The pet grooming comb as claimed in claim 12, wherein said body portion of said housing has two said outer second through holes, and said shaft has two said mounting holes, and one of said decorative boards has two said second posts respectively inserted in said second outer through holes and said mounting holes.
